(19) United States
(12) Patent Application Publication
(10) Pub. No.: US 2016/0061931 A1
(43) Pub. Date: Mar. 3, 2016

(54) ESTIMATION SYSTEM AND RECEPTION NODE

(71) Applicant: KABUSHIKI KAISHA TOSHIBA, Tokyo (JP)

(72) Inventors: Takafumi SAKAMOTO, Tokyo (JP); Yuji TOHZAKA, Kawasaki (JP); Yusuke DOI, Yokohama (JP)

(21) Appl. No.: 14/839,204

(22) Filed: Aug. 28, 2015

(30) Foreign Application Priority Data
Aug. 29, 2014 (JP) 2014-176091

(51) Int. Cl. G01S 3/808; H04W 56/00

(52) U.S. Cl. CPC G01S 3/8083; H04W 56/0015

(57) ABSTRACT

According to an embodiment, an estimation system includes a first node, a second node, and an estimator. The estimator estimates, based on a propagation time of a wave, (i) a distance from a first transmission source having transmitted the wave to the first node or (ii) a location of the first transmission source or the first node. The first node includes a wave receiver and a first wireless communicator. The wave receiver receives the wave. The first wireless communicator incorporates a first timer, synchronizes the first timer with a second timer built in the second node via wireless communication with the second node, acquires reception time information indicative of a point in time of reception of the wave from the first timer, and outputs the reception time information to the estimator.

### CROSS-REFERENCE TO RELATED APPLICATIONS

This application is based upon and claims the benefit of priority from Japanese Patent Application No. 2014-176091, filed Aug. 29, 2014, the entire contents of which are incorporated herein by reference.

### FIELD

Embodiments relate to estimation of a distance or a location based on wave propagation time.

### BACKGROUND

GPS (Global Positioning System) is conventionally utilized to estimate location information for car navigation systems, smartphones, and the like. However, in an environment where radio waves from satellites are difficult to receive (for example, in a closed environment), estimating location information utilizing GPS is difficult.

### BRIEF DESCRIPTION OF THE DRAWINGS

FIG. 1 is a block diagram illustrating a location estimation system according to a first embodiment;

FIG. 2 is a block diagram illustrating a wave reception node in FIG. 1;

FIG. 3 is a flowchart illustrating operations of a communication controller in FIG. 2;

FIG. 4 is a block diagram depicting a modification of the system in FIG. 1;

FIG. 5 is a block diagram depicting a modification of the system in FIG. 1;

FIG. 6 is a block diagram depicting a modification of the system in FIG. 1;

FIG. 7 is a block diagram illustrating a wave reception node included in a location estimation system according to a second embodiment;

FIG. 8 is a flowchart illustrating operations of a communication controller in FIG. 7;

FIG. 9 is a block diagram illustrating a location estimation system according to a third embodiment;

FIG. 10 is a block diagram illustrating a wave transmission and reception node in FIG. 9;

FIG. 11 is a flowchart illustrating operations of a communication controller in FIG. 10;

FIG. 12 is a block diagram illustrating a location estimation system according to a fourth embodiment;

FIG. 13 is a block diagram illustrating a wave transmission node in FIG. 12;

FIG. 14 is a block diagram illustrating a wave reception node in FIG. 12;

FIG. 15 is a block diagram illustrating a location estimation system according to a fifth embodiment;

FIG. 16 is a block diagram illustrating a wave reception node in FIG. 15;

FIG. 17 is a sequence diagram illustrating operations of the location estimation system in FIG. 12; and

FIG. 18 is a sequence diagram illustrating operations of the location estimation system in FIG. 15.

### DETAILED DESCRIPTION

Embodiments will be described below with reference to the drawings.

According to an embodiment, an estimation system includes a node group and an estimator. The node group includes a first node receiving a first wave and a second node communicating wirelessly with the first node. The estimator estimates, based on a propagation time of the first wave, (i) a distance from a first transmission source having transmitted the first wave to the first node or (ii) a location of the first transmission source or the first node. The first node includes a first wave receiver and a first wireless communicator. The first wave receiver receives the first wave. The first wireless communicator incorporates a first timer, synchronizes the first timer with a second timer built in the second node via wireless communication with the second node, acquires a first piece of reception time information indicative of a point in time of reception of the first wave from the first timer, and outputs the first piece of reception time information to the estimator.

According to another embodiment, an estimation system includes a transmission node group, a reception node and an estimator. The transmission node group includes a first transmission node, a second transmission node, a third transmission node, and a fourth transmission node that transmit a first wave, a second wave, a third wave, and a fourth wave and communicates wirelessly with one another. The reception node receives the first wave, the second wave, the third wave, and the fourth wave. The estimator estimates a location of the reception node based on propagation times of the first wave, the second wave, the third wave, and the fourth wave. The first transmission node includes a first wave transmitter and a first wireless communicator. The first wave transmitter transmits the first wave. The first wireless communicator incorporates a first timer, synchronizes the first timer with a second timer, a third timer, and a fourth timer built in the second transmission node, the third transmission node, and the fourth transmission node via wireless communication with the second transmission node, the third transmission node, and the fourth transmission node, and controls a timing when the first wave transmitter transmits the first wave based on a timer value of the first timer. The second transmission node includes a second wave transmitter and a wireless communicator. The second wave transmitter transmits the second wave. The second wireless communicator incorporates the second timer, synchronizes the second timer with the first timer, the third timer, and the fourth timer via wireless communication with the first transmission node, the third transmission node, and the fourth transmission node, and controls a timing when the second wave transmitter transmits the second wave based on a timer value of the second timer. The third transmission node includes a third wave transmitter and a third wireless communicator. The third wave transmitter transmits the third wave. The third wireless communicator incorporates the third timer, synchronizes the third timer with the first timer, the second timer, and the fourth timer via wireless communication with the first transmission node, the second transmission node, and the fourth transmission node, and controls a timing when the third wave transmitter transmits the third wave based on a timer value of the third timer. The fourth transmission node includes a fourth wave transmitter and a fourth wireless communicator. The fourth wave transmitter transmits the fourth wave. The fourth wireless communicator incorporates the fourth timer, synchronizes the fourth timer with the first timer, the second timer, and the third timer via wireless communication with the first transmission node, the second transmission node, and the third transmission node, and controls a timing when the fourth wave transmitter transmits the fourth wave based on a timer value of the fourth timer. The reception node notifies the estimator that the reception node has received the first wave, the second wave, and the third wave. The estimator calculates propagation time differences between a propagation time of the first wave from the first transmission node to the reception node and propagation times of the second wave, the third wave, and the fourth wave from the second transmission node, the third transmission node, and the fourth transmission node to the reception node based on points in time of reception of notifications that the first wave, the second wave, the third wave, and the fourth wave, respectively, have been received from the reception node, to estimate the location of the reception node based on the propagation time differences.

According to another embodiment, a reception node includes a wave receiver and a wireless communicator. The wave receiver receives a sound wave. The wireless communicator incorporates a first timer, synchronizes the first timer with a second timer built in another node via wireless communication with the other node, and acquires reception time information indicative of a point in time of reception of the sound wave from the first timer.

Elements identical or similar to described elements are denoted by identical or similar elements, and duplicate descriptions are basically omitted. For example, when a plurality of identical or similar elements is present, a common reference numeral may be used in order to avoid distinguishing the elements from one another in the description or branch numbers may be used in addition to the common reference numeral in order to distinguish the elements from one another in the description.

### First Embodiment

As illustrated in FIG. 1, a location estimation system according to a first embodiment includes four wave reception nodes 100-1, 100-2, 100-3, and 100-4, a wave transmission source 130, and a location estimator 140. The total number of wave reception nodes 100 may be five or more.

The wave transmission source 130 can transmit a wave. The wave may have a predetermined characteristic as described below so as to be distinguishable from other waves. A sound wave (including an ultrasonic wave) is hereinafter utilized as the wave. However, any other wave such as an electromagnetic wave or an oscillatory wave may be utilized. The wave transmission source 130 may be an apparatus such as a robot with a loudspeaker or a living organism such as an animal or a human being. When the wave transmission source 130 is a living organism, voices, calls, or vibration from the living organism corresponds to the wave.

The wave reception nodes 100-1, 100-2, 100-3, and 100-4 receive a wave. Upon detecting that the received wave has, for example, the above-described characteristic, the wave reception nodes 100-1, 100-2, 100-3, and 100-4 acquire information indicative of the point in time of reception of the wave (hereinafter referred to as reception time information). The reception time information may be, for example, a timer value. In order to reduce the magnitude of location estimation errors, timers referenced by the wave reception nodes 100-1, 100-2, 100-3, and 100-4 preferably synchronize accurately with one another. The reception time information is collected by the location estimator 140.

Specifically, the wave reception node 100 includes a wave receiver 110 and a wireless communicator 120. The wave receiver 110 receives a wave transmitted by the wave transmission source 130. Upon detecting that the received wave has the above-described characteristic, the wave receiver 110 notifies the wireless communicator 120 that the desired wave has been received.

Upon receiving the notification from the wave receiver 110, the wireless communicator 120 accesses a built-in timer to acquire the reception time information. The wireless communicator 120 outputs the reception time information to the location estimator 140. The location estimator 140 may be connected to any one of the wave reception nodes 100-1, 100-2, 100-3, and 100-4 in a wired or wireless manner. When directly connected to the location estimator 140, the wireless communicator 120 outputs the reception time information directly to the location estimator 140. On the other hand, when not directly connected to the location estimator 140, the wireless communicator 120 outputs the reception time information to the location estimator 140 via another wave reception node 100.

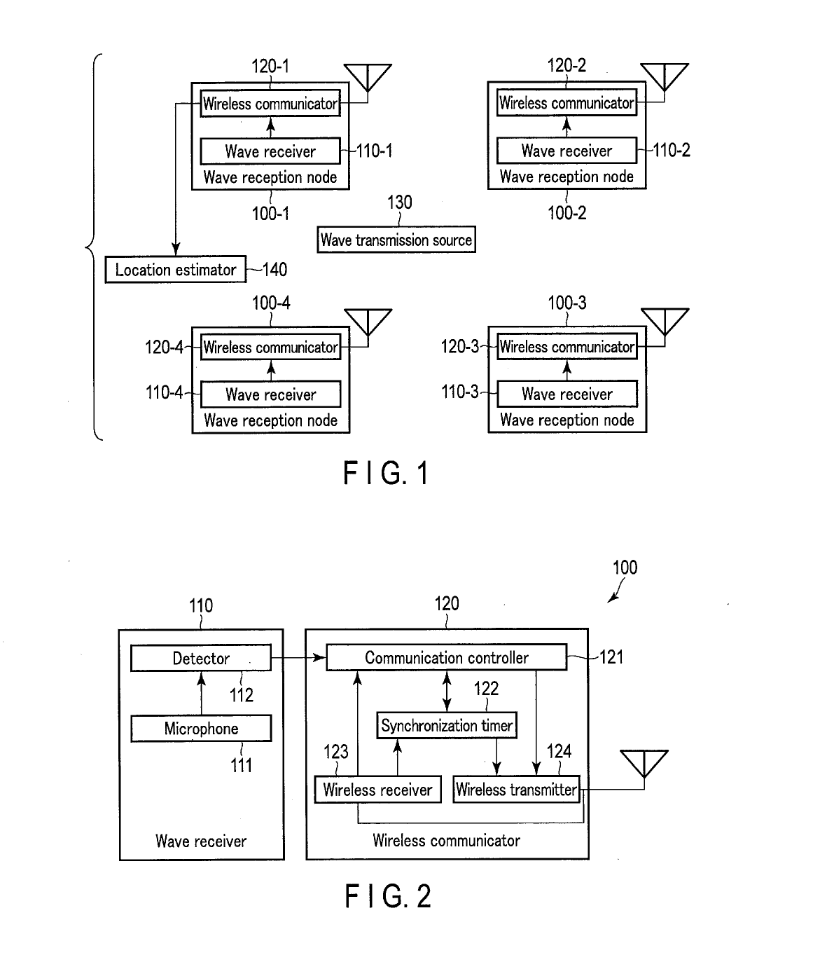

A specific example of the wave reception node 100 is depicted in FIG. 2. The wave receiver 110 includes a microphone 111 and a detector 112. The wireless communicator 120 includes a communication controller 121, a synchronization timer 122, a wireless receiver 123, and a wireless transmitter 124.

The microphone 111 receives and converts a sound wave into an electric signal. The microphone 111 outputs the electric signal to the detector 112.

The detector 112 receives the electric signal from the microphone 111, and checks whether or not the electric signal has a predetermined characteristic. Upon detecting that the electric signal has a predetermined characteristic, the detector 112 notifies the communication controller 121 that the desired wave has been received. For example, the sound wave from the wave transmission source 130 may have a predetermined sound pressure level, a predetermined time waveform, or a predetermined frequency component as a predetermined characteristic.

The communication controller 121 controls the synchronization timer 122, the wireless receiver 123, and the wireless transmitter 124. For example, upon receiving the notification from the detector 112, the communication controller 121 acquires a timer value from the synchronization timer 122. The timer value corresponds to the reception time information. The communication controller 121 outputs the reception time information to the location estimator 140.

Specifically, when directly connected to the location estimator 140, the communication controller 121 outputs the reception time information directly to the location estimator 140. On the other hand, when not directly connected to the location estimator 140, the communication controller 121 allows the wireless transmitter 124 to transmit the reception time information to the location estimator 140 or another wave reception node 100. When the wireless receiver 123 receives the reception time information from another wave reception node 100, the communication controller 121 similarly outputs the reception time information to the location estimator 140.

Moreover, the communication controller 121 executes a synchronization process for synchronizing the synchronization timer 122 with the synchronization timer 122 built in another wave reception node 100. For example, the communication controller 121 may allow the wireless transmitter 124 to transmit the timer value of the synchronization timer 122 to another wave reception node 100 or may correct the timer value of the synchronization timer 122 using the timer value in another wave reception node 100 received by the wireless receiver 123.

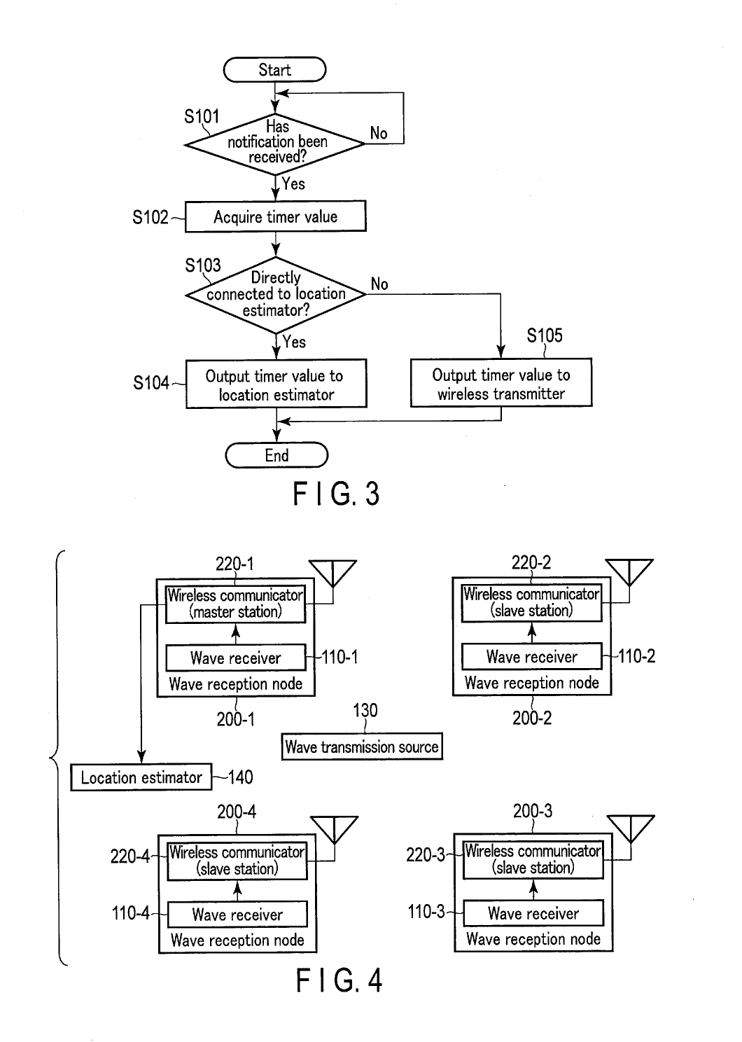

Specifically, the communication controller 121 may operate as illustrated in FIG. 3. First, the communication controller 121 continues to wait for a notification from the detector 112 (step S101). Then, upon receiving a notification from the detector 112, the communication controller 121 acquires the timer value of the synchronization timer 122 (step S102).

When directly connected to the location estimator 140, the communication controller 121 outputs the timer value acquired in step S102 directly to the location estimator 140 (step S103 and step S104). On the other hand, when not directly connected to the location estimator 140, the communication controller 121 allows the wireless transmitter 124 to transmit the timer value acquired in step S102 to the location estimator 140 or another wave reception node 100 (step S103 and step S105).

The synchronization timer 122 obtains the timer value by performing a count-up operation in synchronization with a clock signal. The synchronization timer 122 is controlled by the communication controller 121 so as to synchronize with the synchronization timer 122 built in another wave reception node 100. For example, given that the wireless communicator 120 corresponds to wireless LAN equipment compliant with IEEE 802.11, the synchronization timer 122 may be implemented by a TSF (Timing Synchronization Function) timer. The synchronization process for the TSF timer varies depending on the network configuration (infrastructure mode or ad hoc mode) but enables accurate synchronization in any network configurations. For example, according to IEEE 802.11, the synchronization error between TSF timers is at most several microseconds. Furthermore, even when the wireless communicator 120 is equipment compliant with another wireless communication standard such as IEEE 802.15.1 or IEEE 802.15.4, if the wireless communicator 120 incorporates a similar timer, the timer can be used.

The wireless receiver 123 receives various types of information in the form of wireless signals. Specifically, the wireless receiver 123 receives the reception time information and information needed for the synchronization process (for example, the timer value of the synchronization timer 122 built in another wave reception node 100) from another wave reception node 100 in the form of wireless signals.

The wireless transmitter 124 transmits various types of information in the form of wireless signals. Specifically, the wireless transmitter 124 transmits the reception time information and information needed for the synchronization process (for example, the timer value of the synchronization timer 122) to another wave reception node 100, the location estimator 140, and the like in the form of wireless signals. The wireless transmitter 124 may transmit the identifier of the wave reception node 100 together with the reception time information. For example, given that the wireless communicator 120 is wireless LAN equipment compliant with IEEE 802.11, the identifier may be a MAC (Media Access Control) address.

The location estimator 140 collects the reception time information from the wave reception nodes 100-1, 100-2, 100-3, and 100-4. The location estimator 140 estimates the location of the wave transmission source 130 based on the collected reception time information, the velocity of the wave, and the location of each wave reception node 100. The location estimator 140 can reference, for example, the identifier and location of each wave reception node 100 and the velocity of the wave. The identifier and location of each wave reception node 100 may be registered when the wave reception node 100 is installed.

When the location of the wave transmission source 130 is represented as (x, y, z), the location of the wave reception node 100-i (i is an integer of at least 1 and at most 4) is represented as (xᵢ, yᵢ, zᵢ), the time of wave propagation from the and reception node from the wave transmission source 130 to the wave reception node 100-i is represented as tᵢ, and the velocity of the wave (for example, a sound wave) is represented as v, Expression (1) holds true.

$${vt}_{i} = \sqrt{{( x - {x}_{i} )}^{2} + {( y - {y}_{i} )}^{2} + {( z - {z}_{i} )}^{2}} \qquad ( 1 )$$

Moreover, for i >1, when the difference between the reception time information collected from the wave reception node 100-i and the reception time information collected from the wave reception node 100-1 is represented as Δtᵢ, Expression (2) holds true.

tᵢ=t₁+Δtᵢ (2)

Based on Expressions (1) and (2), the following linear simultaneous equation with four unknowns holds true for unknowns x, y, x, and tᵢ.

$$\{ \begin{matrix}{vt}_{1} = \sqrt{{( x - {x}_{1} )}^{2} + {( y - {y}_{1} )}^{2} + {( z - {z}_{1} )}^{2}} \\ v ( {t}_{1} + Δ {t}_{2} ) = \sqrt{{( x - {x}_{2} )}^{2} + {( y - {y}_{2} )}^{2} + {( z - {z}_{2} )}^{2}} \\ v ( {t}_{1} + Δ {t}_{3} ) = \sqrt{{( x - {x}_{3} )}^{2} + {( y - {y}_{3} )}^{2} + {( z - {z}_{3} )}^{2}} \\ v ( {t}_{1} + Δ {t}_{2} ) = \sqrt{{( x - {x}_{4} )}^{2} + {( y - {y}_{4} )}^{2} + {( z - {z}_{4} )}^{2}}\end{matrix} \qquad ( 3 )$$

In Expression (3), v, x₁, y₁ z₁, x₂, y₂, z₂, x₃, y₃, z₃, x₄, y₄, and z₄ are known to the location estimator 140. Furthermore, the location estimator 140 can calculate Δt₂, Δt₃, and Δt₄ based on the reception time information collected from the wave reception nodes 100-1, 100-2, 100-3, and 100-4. Hence, the location estimator 140 can calculate the location (x, y, z) of the wave transmission source 130 by solving Expression (3). Moreover, the location estimator 140 can calculate the distance from the wave reception node 100-i to the wave transmission source 130 by, for example, substituting x, y, and z into the right side of Expression (1).

In FIG. 1, the wireless communicators 120-1, 120-2, 120-3, and 120-4 are depicted to form a peer-to-peer network in, for example, an ad hoc mode in IEEE 802.11. However, the wireless communicators 120-1, 120-2, 120-3, and 120-4 may form a star network in, for example, an infrastructure mode in IEEE 802.11.

For example, the location estimation system in FIG. 1 may be modified as illustrated in FIG. 4. The location estimation system in FIG. 4 includes the location estimator 140, the wave transmission source 130, and four wave reception nodes 200-1, 200-2, 200-3, and 200-4. The total number of wave reception nodes 200 may be five or more.

A wireless communicator 220-1 included in the wave reception node 200-1 functions as a master station corresponding to a hub of the star network (for example, an AP (Access Point) in IEEE 802.11). On the other hand, wireless communicators 220-2, 220-3, and 220-4 included in the wave reception nodes 200-2, 200-3, and 200-4 function as slave stations (for example, STA (Stations) in IEEE 802.11).

In general, in the star network, the master station can communicate directly with the slave stations. On the other hand, each of the slave stations can communicate with the other slave stations via the master station. The example in FIG. 4 where the location estimator 140 is connected to the master station enables a reduction in traffic for the reception time information compared to a case where the location estimator 140 is connected to the slave station.

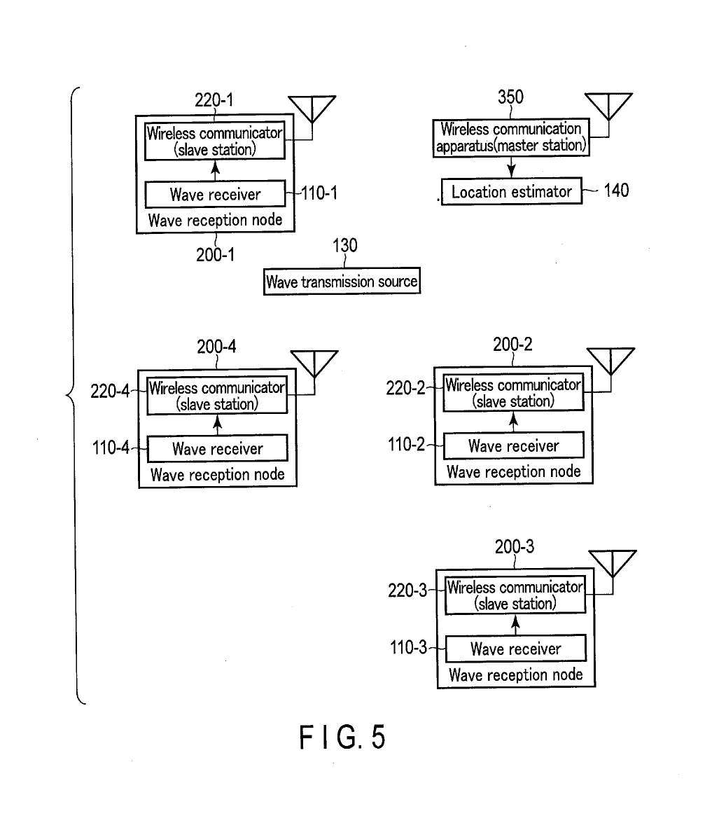

It should be noted that the master station undergoes a heavier communication load than the slave stations. Thus, a timing when the timer value (for example, the reception time information) of the built-in timer may be delayed, which degrades location estimation accuracy. Hence, the master station may be prepared separately from the wave reception node as illustrated in FIG. 5. The location estimation system in FIG. 5 includes the location estimator 140, the wave transmission source 130, the four wave reception nodes 200-1, 200-2, 200-3, and 200-4, and a wireless communication apparatus 350. The total number of wave reception nodes 200 may be five or more.

The wireless communication apparatus 350 functions as a master station corresponding to the hub of the star network (for example, an AP (Access Point) in IEEE 802.11). On the other hand, the wireless communicators 220 included in each wave reception node 200 function as slave stations (for example, STA (Stations) in IEEE 802.11).

The wireless communication apparatus 350 serving as the master station collects the reception time information from the wave reception nodes 200 and outputs the reception time information to the location estimator 140. Each wireless communicator 220 needs to be designed to have a function to acquire the timer value of the built-in timer. However, the wireless communication apparatus 350 needs no such function. Thus, the wireless communication apparatus 350 can be implemented even by a general-purpose AP as long as the AP meets basic usage conditions, for example, the number of simultaneous connections.

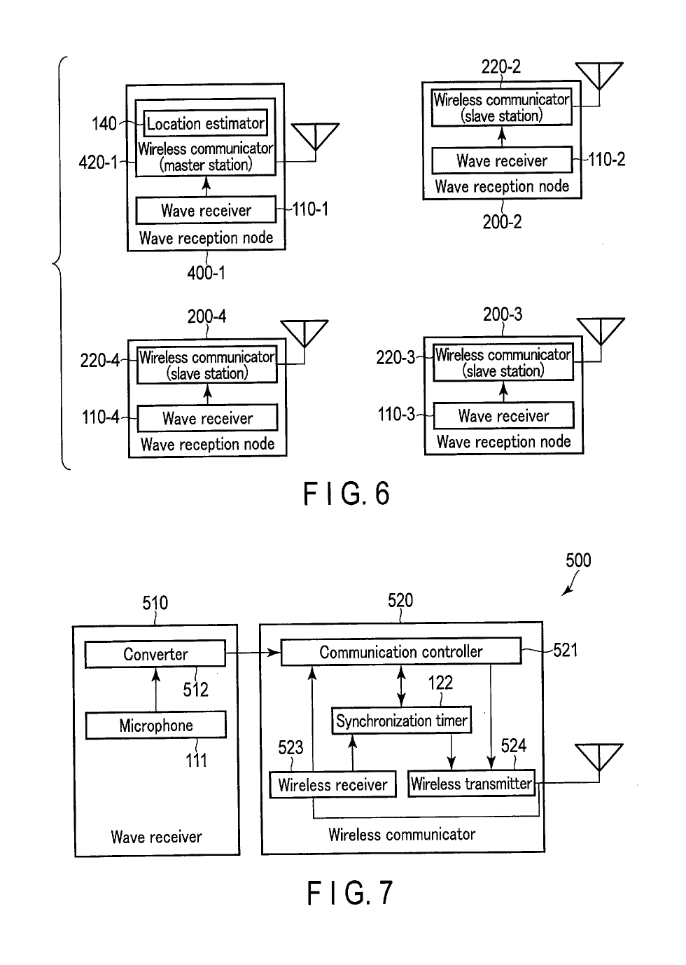

Moreover, the location estimator 140 need not be an apparatus independent of the wireless communicator (for example, PC (Personal Computer)). For example, as depicted in FIG. 6, the location estimator 140 may be incorporated into a wireless communicator 420-1 (master station) of a wave reception node 400. When the location estimator 140 is incorporated into the wireless communicator 420-1, the number of apparatuses included in the location estimation system according to the present embodiment can be reduced, facilitating installation of the location estimation system. The location estimator 140 may be incorporated into the slave station instead of the master station.

As described above, the location estimation system according to the first embodiment includes the four or more wave reception nodes, and the wireless communicators included in the respective wave reception nodes form a wireless communication network. Each wave reception node acquires the reception time information on the wave transmitted by the wave transmission source, from the timer built in the wireless communicator, and outputs the reception time information to the location estimator.

The location estimator estimates the location of the wave transmission source based on the collected reception time information, the velocity of the wave, and the location of each wave reception node. The timers synchronize accurately with one another among the wave reception nodes, and thus, the location estimator can collect accurate wave propagation time differences among the wave reception nodes to accurately estimate the location of the wave transmission source 130.

Furthermore, the wave reception node can acquire the reception time information from the timer built in the wireless communicator in the wave reception node. That is, the wave reception node need not separately have, for example, hardware or software configured to execute a time synchronization process based on the NTP (Network Time Protocol). The location estimation system needs no special apparatus for time synchronization such as an NTP server. In addition, the wave reception nodes are wirelessly connected together. Thus, no communication cable needs to be laid, and the wireless communicator included in the wave reception node may be implemented using, for example, general-purpose wireless LAN equipment compliant with IEEE 802.11. Hence, the location estimation system can be inexpensively, simply, and compactly constructed, and the apparatuses included in the location estimation system can be easily installed.

### Second Embodiment

A location estimation system according to a second embodiment corresponds to the location estimation system in FIG. 1 in which the location estimator 140 is replaced with a location estimator 540 and in which each wave reception node 100 is replaced with a wave reception node 500. The total number of wave reception nodes 500 may be five or more.

The wave reception node 500 receives a wave to acquire reception time information. Specifically, the wave reception node 500 includes a wave receiver 510 and a wireless communicator 520. The wave receiver 510 receives a wave transmitted by a wave transmission source 130. The wave receiver 510 converts the received wave into digital data (hereinafter referred to as wave data) and outputs the wave data to the wireless communicator 520.

Upon receiving a notification from the wave receiver 510, the wireless communicator 520 accesses a built-in timer to acquire the reception time information. The wireless communicator 520 outputs the reception time information and the wave data to the location estimator 540. The location estimator 540 may be connected to any one of the wave reception nodes 500-1, 500-2, 500-3, and 500-4 in a wired or wireless manner. When directly connected to the location estimator 540, the wireless communicator 520 outputs the reception time information and the wave data directly to the location estimator 540. On the other hand, when not directly connected to the location estimator 540, the wireless communicator 520 outputs the reception time information and the wave data to the location estimator 540 via another wave reception node 500.

A specific example of the wave reception node 500 is depicted in FIG. 7. The wave receiver 510 includes a microphone 111 and a converter 512. The wireless communicator 520 includes a communication controller 521, a synchronization timer 122, a wireless receiver 523, and a wireless transmitter 524.

The converter 512 receives an electric signal from the microphone 111 and converts the electric signal into wave data. The converter 512 outputs the wave data to the communication controller 521. The converter 512 may sequentially convert a sound wave into frames at predetermined intervals to generate wave data in a sound frame format.

The communication controller 521 controls the synchronization timer 122, the wireless receiver 523, and the wireless transmitter 524. For example, upon receiving the wave data, the communication controller 521 acquires the timer value of the synchronization timer 122. The timer value corresponds to information indicative of the point in time of reception of a sound wave by the wave reception node 500 from the wave transmission source 130. The communication controller 521 outputs the reception time information and the wave data to the location estimator 540.

Specifically, when directly connected to the location estimator 540, the communication controller 521 outputs the reception time information and the wave data directly to the location estimator 540. On the other hand, when not directly connected to the location estimator 540, the communication controller 521 allows the wireless transmitter 524 to transmit the reception time information and the wave data to the location estimator 540 or another wave reception node 500. When the wireless receiver 523 receives the reception time information and the wave data from another wave reception node 500, the communication controller 521 similarly outputs the reception time information and the wave data to the location estimator 540.

Moreover, the communication controller 521 executes a synchronization process for synchronizing the synchronization timer 122 with the synchronization timer 122 built in another wave reception node 500. For example, the communication controller 521 may allow the wireless transmitter 524 to transmit the timer value of the synchronization timer 122 to another wave reception node 500 or may correct the timer value of the synchronization timer 122 using the timer value in another wave reception node 500 received by the wireless receiver 523.

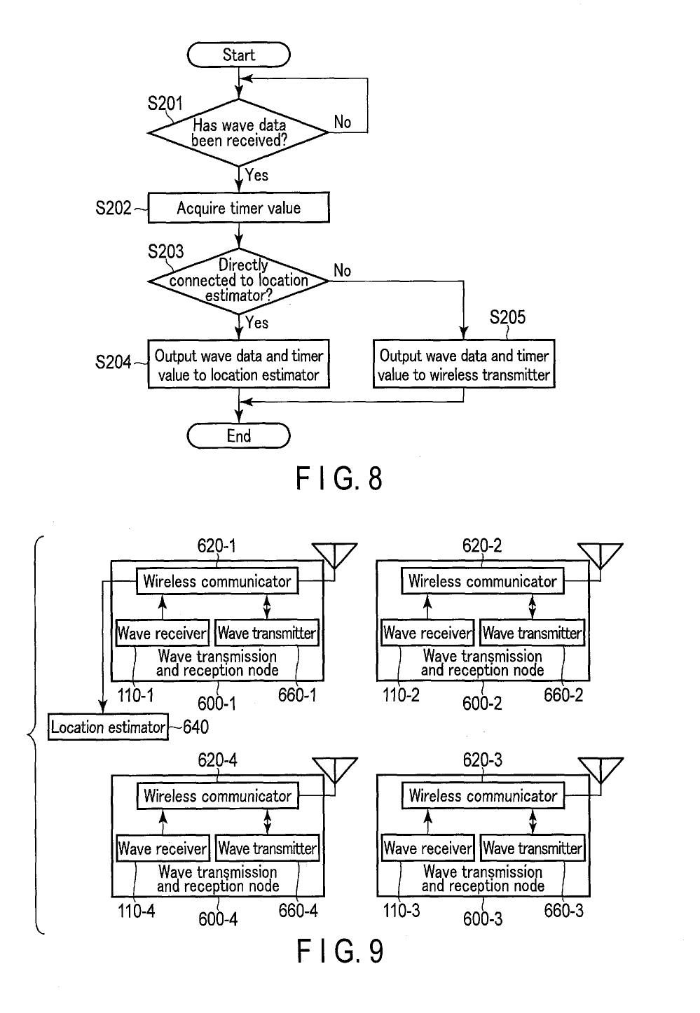

Specifically, the communication controller 521 may operate as illustrated in FIG. 8. First, the communication controller 521 continues to wait for the wave data from the converter 512 (step S201). Then, upon receiving the wave data from the converter 512, the communication controller 521 acquires the timer value of the synchronization timer 122 (step S202).

When directly connected to the location estimator 540, the communication controller 521 outputs the timer value and wave data acquired in step S202 directly to the location estimator 540 (step S203 and step S204). On the other hand, when not directly connected to the location estimator 540, the communication controller 521 allows the wireless transmitter 524 to transmit the timer value and wave data acquired in step S202 to the location estimator 140 or another wave reception node 500 (step S203 and step S205).

The wireless receiver 523 receives various types of information in the form of wireless signals. Specifically, the wireless receiver 523 receives the reception time information, the wave data, and information needed for the synchronization process (for example, the timer value of the synchronization timer 122 built in another wave reception node 500) from another wave reception node 100 in the form of wireless signals.

The wireless transmitter 524 transmits various types of information in the form of wireless signals. Specifically, the wireless transmitter 524 transmits the reception time information, the wave data, and information needed for the synchronization process (for example, the timer value of the synchronization timer 122) to another wave reception node 500, the location estimator 540, and the like in the form of wireless signals. The wireless transmitter 524 may transmit the identifier of the wave reception node 500 together with the reception time information and the wave data.

The location estimator 540 collects the reception time information and the wave data from the wave reception nodes 500-1, 500-2, 500-3, and 500-4. As described above, the sound wave from the wave transmission source 130 may have, for example, predetermined sound pressure level, a predetermined time waveform, or a predetermined frequency component as a predetermined characteristic in order to be distinguished from other sound waves. Upon detecting that the collected wave data has the predetermined characteristic, the location estimator 540 estimates the location of the wave transmission source 130 based on the reception time information corresponding to the wave data, the velocity of the wave, and the location of each wave reception node 500. The location estimator 540 may neglect the wave data and the corresponding reception time information when the collected wave data does not include the predetermined characteristic. The location estimator 540 can reference, for example, the identifier and location of each wireless communicator 520 and the velocity of the wave. The identifier and location of each wireless communicator 520 may be registered when the wave reception node 500 is installed.

The wireless communicators 520-1, 520-2, 520-3, and 520-4 may form a star network instead of a peer-to-peer network. Furthermore, a master station may be provided independently of the wave reception node 500. Moreover, the location estimator 540 may be incorporated into any one of the wireless communicators 520.

As described above, the location estimation system according to the second embodiment is different from the location estimation system according to the first embodiment in that the process in which, instead of each wave reception node, the location estimator intensively checks whether or not the wave received by the wave reception node has the predetermined characteristic. Thus, the location estimation system enables complicated analysis to be executed on the wave data by implementing the location estimator using, for example, a sophisticated computer. This allows the wave transmitted by the desired wave transmission source to be more accurately identified. On the other hand, in the location estimation system, the wave receiver included in the wave reception node need only convert the received wave into wave data without analyzing the wave. Thus, the second embodiment can be simplified compared to the first embodiment. In addition, the location estimation system allows effects identical or similar to the effects of the first embodiment to be exerted.

### Third Embodiment

As illustrated in FIG. 9, a location estimation system according to a third embodiment includes four wave transmission and reception nodes 600-1, 600-2, 600-3, and 600-4 and a location estimator 640. The total number of wave transmission and reception nodes 600 may be five or more. Furthermore, some of the wave transmission and reception nodes 600 may be replaced with wave reception nodes.

In the location estimation system in FIG. 9, one of the wave transmission and reception nodes 600 (that is assumed to be, for example, the wave transmission and reception node 600-1) transmits a wave, and the remaining wave transmission and reception nodes 600 (that are assumed to be, for example, the wave transmission and reception nodes 600-2, 600-3, and 600-4) receive the waves. The location estimator 640 can calculate the wave propagation times of propagation for the respective wave transmission and reception nodes 600-2, 600-3, and 600-4 by subtracting the point in time of transmission of the wave by the wave transmission and reception node 600-1 from the point in time of reception of the wave by each of the wave transmission and reception nodes 600-2, 600-3, and 600-4. Based on the wave propagation times, the location estimator 640 estimates the location of the wave transmission and reception node 600 having transmitted the wave and estimates the distance between the wave transmission and reception node 600 having transmitted the wave and any of the wave transmission and reception nodes 600 having received the wave.

The wave transmission and reception node 600 can transmit a wave (for example, a sound wave). The wave may have a predetermined characteristic in order to be distinguished from other waves. The wave transmission and reception node 600 may be an apparatus such as a robot with a loudspeaker. Upon transmitting the wave, the wave transmission and reception node 600 acquires information indicative of the corresponding time (hereinafter referred to as transmission time information). The transmission time information may be, for example, a timer value. In order to reduce the magnitude of location estimation errors, timers referenced by the wave transmission and reception nodes 600-1, 600-2, 600-3, and 600-4 preferably synchronize accurately with one another. Moreover, the wave transmission and reception node 600 can receive the wave. Upon detecting that the received wave has the predetermined characteristic, the wave transmission and reception node 600 acquires reception time information.

Specifically, the wave transmission and reception node 600 includes a wave receiver 110, a wireless communicator 620, and a wave transmitter 660. The wave transmitter 660 transmits the wave with the predetermined characteristic and notifies the wireless communicator 620 that the wave transmitter 660 has transmitted the wave.

Upon receiving a notification from the wave receiver 110, the wireless communicator 620 accesses a built-in timer to acquire the reception time information. Upon receiving the notification from the wave transmitter 660, the wireless communicator 620 accesses the built-in timer to acquire the transmission time information. The wireless communicator 620 outputs the reception time information or the transmission time information to the location estimator 640. The location estimator 640 may be connected to any one of the wave transmission and reception nodes 600-1, 600-2, 600-3, and 600-4 in a wired or wireless manner. When directly connected to the location estimator 640, the wireless communicator 620 outputs the reception time information or the transmission time information directly to the location estimator 640. On the other hand, when not directly connected to the location estimator 640, the wireless communicator 620 outputs the reception time information or the transmission time information to the location estimator 640 via another wave transmission and reception node 600.

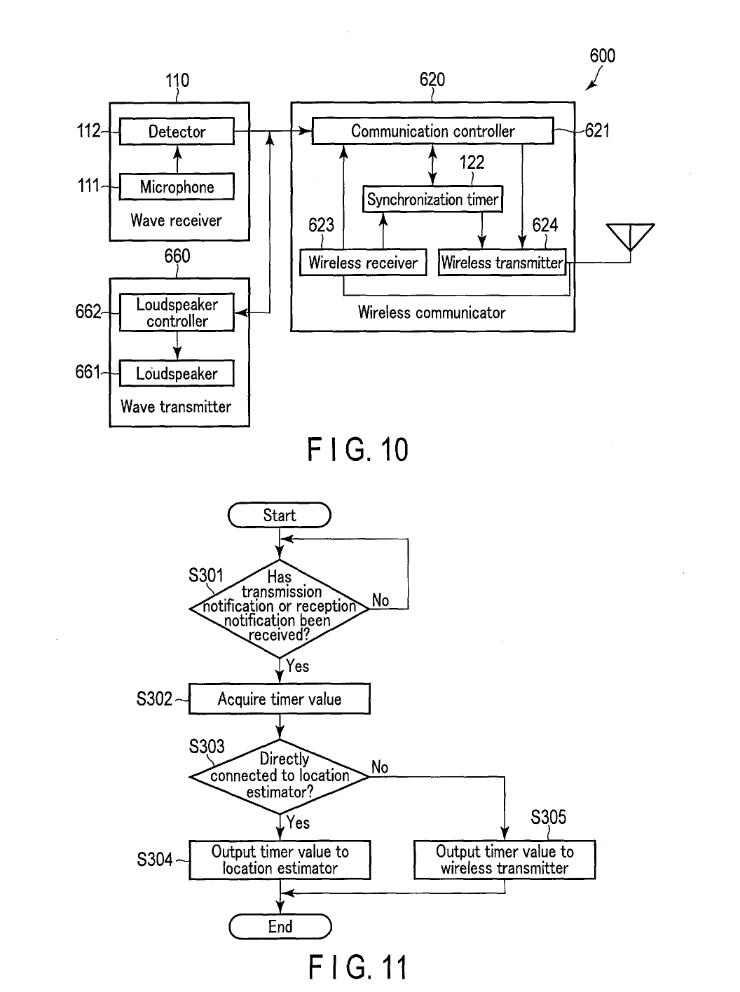

A specific example of the wave transmission and reception node 600 is depicted in FIG. 10. The wireless communicator 620 includes a communication controller 621, a synchronization timer 122, a wireless receiver 623, and a wireless transmitter 624. The wave transmitter 660 includes a loudspeaker 661 and a loudspeaker controller 662.

The loudspeaker controller 662 gives a transmission instruction to the loudspeaker 661 at a predetermined timing to allow the loudspeaker 661 to transmit a sound wave with a predetermined characteristic. The loudspeaker controller 662 may give the transmission instruction upon receiving the transmission instruction from the communication controller 621. Moreover, the loudspeaker controller 662 notifies the communication controller 621 that the loudspeaker 661 has transmitted the sound wave.

Upon receiving the transmission instruction, the loudspeaker 661 transmits the sound wave with the predetermined characteristic. For example, the sound wave transmitted by the loudspeaker 661 may have a predetermined sound pressure level, a predetermined time waveform, or a predetermined frequency component.

The communication controller 621 controls the synchronization timer 122, the wireless receiver 623, and the wireless transmitter 624. For example, upon receiving a notification from the detector 112 or the loudspeaker controller 662, the communication controller 621 acquires the timer value of the synchronization timer 122. The timer value corresponds to the reception time information or the transmission time information. The communication controller 621 outputs the reception time information or the transmission time information to the location estimator 640. The communication controller 621 may further output, in addition to the timer value, information indicating whether the timer value corresponds to the reception time information or the transmission time information.

Specifically, when directly connected to the location estimator 640, the wireless communicator 621 outputs the reception time information and the transmission time information directly to the location estimator 640. On the other hand, when not directly connected to the location estimator 640, the wireless communicator 621 outputs the reception time information or the transmission time information to the location estimator 640 via another wave transmission and reception node 600. When the wireless receiver 623 receives the reception time information or the transmission time information from another wave transmission and reception node 600, the communication controller 621 similarly outputs the reception time information or the transmission time information to the location estimator 640.

Moreover, the communication controller 621 executes a synchronization process for synchronizing the synchronization timer 122 with the synchronization timer 122 built in another wave transmission and reception node 600. For example, the communication controller 621 may allow the wireless transmitter 624 to transmit the timer value of the synchronization timer 122 to another wave transmission and reception node 600 or may correct the timer value of the synchronization timer 122 using the timer value in another wave transmission and reception node 600 received by the wireless receiver 623.

In addition, the communication controller 621 may give a transmission instruction to the loudspeaker controller 662 to allow the loudspeaker controller 662 to transmit a sound wave through the loudspeaker 661. Upon receiving a transmission instruction from the location estimator 640, the communication controller 621 may give the transmission instruction to the loudspeaker controller 662. In this case, the location estimator 640 need not directly be connected to the communication controller 621. For example, the transmission instruction may be wirelessly transmitted by another wireless communicator 620.

Specifically, the communication controller 621 may operate as illustrated in FIG. 11. First, the communication controller 621 continues to wait for a notification from the detector 112 (notification of reception) or a notification from the loudspeaker controller 662 (notification of transmission) (step S301). Then, upon receiving the transmission notification or the reception notification, the communication controller 621 acquires the timer value of the synchronization timer 122 (step S302).

When directly connected to the location estimator 640, the communication controller 621 outputs the timer value acquired in step S302 directly to the location estimator 640 (step S303 and step S304). On the other hand, when not directly connected to the location estimator 640, the communication controller 621 allows the wireless transmitter 624 to transmit the timer value acquired in step S302 to the location estimator 640 or another wave transmission and reception node 600 (step S303 and step S305).

The wireless receiver 623 receives various types of information in the form of wireless signals. Specifically, the wireless receiver 623 receives the reception time information or the transmission time information, and information needed for the synchronization process (for example, the timer value of the synchronization timer 122 built in another wave transmission and reception node 600) from another wave transmission and reception node 600 in the form of wireless signals.

The wireless transmitter 624 transmits various types of information in the form of wireless signals. Specifically, the wireless transmitter 624 transmits the reception time information or the transmission time information, and information needed for the synchronization process (for example, the timer value of the synchronization timer 122) to another wave transmission and reception node 600, the location estimator 640, and the like in the form of wireless signals. The wireless transmitter 624 may transmit the identifier of the wave transmission and reception node 600 together with the reception time information or the transmission time information.

The location estimator 640 collects the reception time information and the transmission time information from the wave transmission and reception nodes 600-1, 600-2, 600-3, and 600-4. The location estimator 640 estimates the location of the wave transmission and reception node 600 having transmitted the wave based on the collected reception time information and transmission time information, the velocity of the wave, and the location of the wave transmission and reception node 600 having received the wave. The location estimator 640 can reference, for example, the identifier and location of the wave transmission and reception node 600 having received the wave, and the velocity of the wave. The identifier and location of the wave transmission and reception node 600 having received the wave may be registered when the wave transmission and reception node 600 is installed.

When the location of the wave transmission and reception node 600-j (j is any integer of at least 1 and at most 4) having transmitted the wave is represented as (x, y, z), the location of the wave transmission and reception node 600-i (i is an integer which is at least 1 and at most 4 and which is different from j) having received the wave is represented as (xᵢ, yᵢ, zᵢ), the time of wave propagation from the wave transmission and reception node 600-j to the wave transmission and reception node 600-i is represented as tᵢ, and the velocity of the wave (for example, a sound wave) is represented as v, then Expression (4) holds true.

$${vt}_{i} = \sqrt{{( x - {x}_{i} )}^{2} + {( y - {y}_{i} )}^{2} + {( z - {z}_{i} )}^{2}} \qquad ( 4 )$$

In Expression (4), v, xᵢ, yᵢ, and z₁ are known to the location estimator 640. Moreover, tᵢ can be calculated using the difference between the reception time information collected from the wave transmission and reception node 600-i and the transmission time information collected from the wave transmission and reception node 600-j. Hence, the location estimator 640 can calculate the location (x, y, z) of the wave transmission and reception node 600-j by solving a linear simultaneous equation with three unknowns derived from Expression (4). Moreover, the location estimator 140 can calculate the distance from the wave transmission and reception node 600-j to the wave transmission and reception node 600-i by, for example, substituting tᵢ into the left side of Expression (4).

When the total number of wave transmission and reception nodes 600 is two, the location estimator 640 can calculate, by allowing one of the wave transmission and reception nodes 600 to transmit the wave, the distance from this wave transmission and reception node 600 to the other wave transmission and reception node 600 based on Expression (4) described above. Moreover, when a new wave transmission and reception node 600 is additionally installed, the location estimator 640 can calculate, by allowing the new wave transmission and reception node 600 to transmit the wave, the distance from the new wave transmission and reception node 600 to each of the two other wave transmission and reception nodes 600 based on Expression (4) described above.

Moreover, given that the locations of three or more wave transmission and reception node 600 are known, the location estimator 640 can estimate the locations of the wave transmission and reception nodes 600 with unknown locations by allowing the wave transmission and reception nodes 600 with unknown locations to transmit the wave. Hence, regardless of the total number of wave transmission and reception nodes 600, as long as an installer or the like registers the locations of at least three wave transmission and reception nodes 600, the location estimator 640 can estimate the locations of the remaining wave transmission and reception nodes 600. That is, regardless of the scale of the location estimation system, the burden of a location measuring operation on the installer or the like can be reduced.

The wireless communicators 620-1, 620-2, 620-3, and 620-4 may form a star network instead of a peer-to-peer network. Furthermore, a master station may be provided independently of the wave transmission and reception node 600. Moreover, the location estimator 640 may be incorporated into any one of the wireless communicators 620.

As described above, the location estimation system according to the third embodiment includes the four or more wave transmission and the reception nodes, and the wireless communicators included in the respective wave transmission and reception nodes form a wireless communication network. The wave transmission and reception node transmitting the wave acquires transmission time information on the wave from the timer built in the wireless communicator in the wave transmission and reception node and outputs the transmission time information to the location estimator. On the other hand, the remaining wave transmission and reception nodes receiving the wave acquire reception time information on the wave from the timers built in the wireless communicators in the wave transmission and reception nodes and output the reception time information to the location estimator.

The location estimator estimates the location of the wave transmission and reception node having transmitted the wave based on the collected transmission time information and reception time information, the velocity of the wave, and the locations of the wave transmission and reception nodes having received the wave. The timers synchronize accurately with one another among the wave transmission and reception nodes, and thus, the location estimator can collect accurate wave propagation times for the wave transmission and reception nodes having received the wave and accurately estimate the location of the wave transmission and reception node having transmitted the wave.

Furthermore, in the location estimation system, when a new wave transmission and reception node is additionally installed, the location of the new wave transmission and reception node can be estimated by allowing the new wave transmission and reception node to transmit the wave. Thus, the installer or the like need not actually measure the additionally installed wave transmission and reception node.

Moreover, the wave transmission and reception node can acquire the transmission time information and the reception time information from the timer built in the wireless communicator in the wave transmission and reception node. That is, the wave transmission and reception node need not separately have, for example, hardware or software configured to execute a time synchronization process based on the NTP. The location estimation system needs no special apparatus for time synchronization such as an NTP server. In addition, the wave reception nodes are wirelessly connected together. Thus, no communication cable needs to be laid, and the wireless communicator included in the wave transmission and reception node may be implemented using, for example, general-purpose wireless LAN equipment compliant with IEEE 802.11. Hence, the location estimation system can be inexpensively, simply, and compactly constructed, and the apparatuses included in the location estimation system can be easily installed.

### Fourth Embodiment

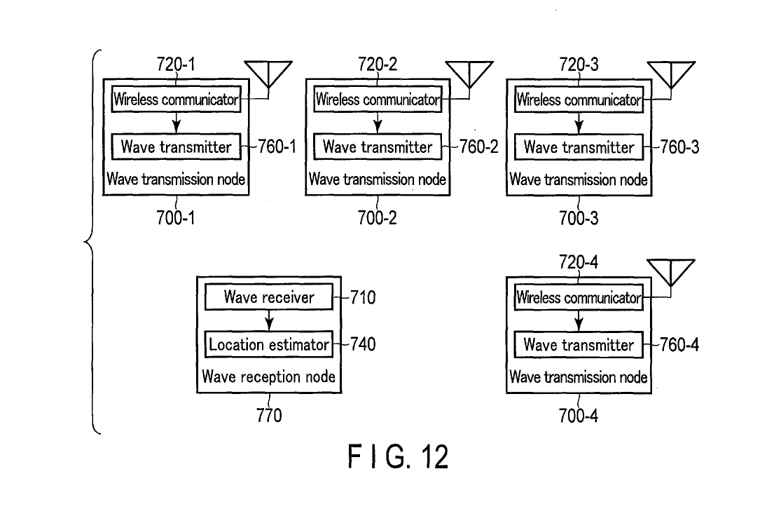

As illustrated in FIG. 12, a location estimation system according to a fourth embodiment includes four wave transmission nodes 700-1, 700-2, 700-3, and 700-4, a location estimator 740, and a wave reception node 770. The total number of wave transmission nodes 700 may be five or more. Furthermore, the wave transmission node 700 or the wave reception node 770 may be replaced with a wave transmission and reception node.

The wave transmission node 700 can transmit a wave (for example, a sound wave). The wave may have a predetermined characteristic in order to be distinguished from other waves. The wave transmission node 700 may be an apparatus such as a robot with a loudspeaker.

Specifically, the wave transmission node 700 includes a wireless communicator 720 and a wave transmitter 760. The wave transmitter 760 transmits the wave with the predetermined characteristic. A timing when the wave transmitter 760 transmits the wave is controlled by the wireless communicator 720.

Each wireless communicator 720 references a timer synchronized with a timer built in another wireless communicator 720 to control the timing when the wave transmitter 760 is allowed to transmit the wave based on the timer value of the timer.

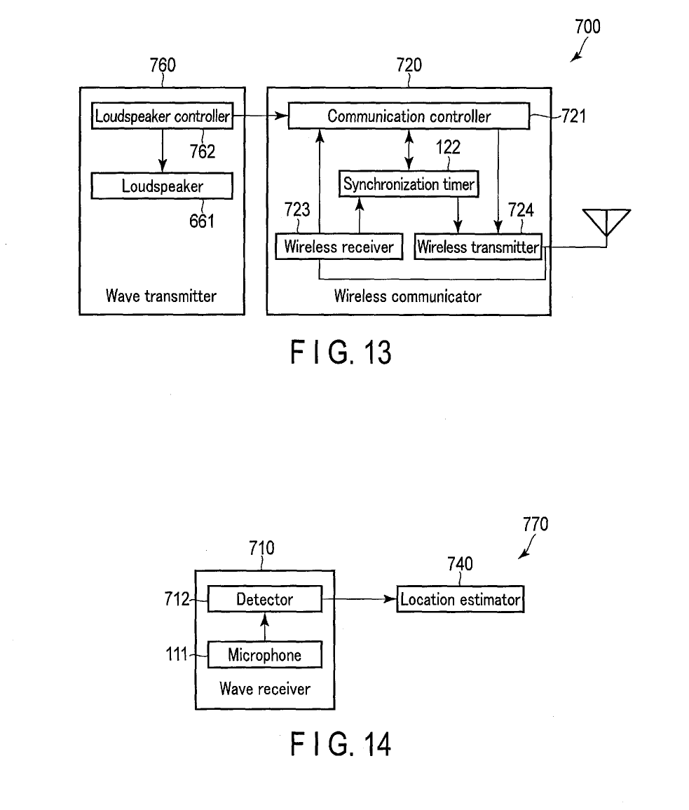

A specific example of the wave transmission node 700 is depicted in FIG. 13. The wireless communicator 720 includes a communication controller 721, a synchronization timer 122, a wireless receiver 723, and a wireless transmitter 724. The wave transmitter 760 includes a loudspeaker 661 and a loudspeaker controller 762.

Upon receiving a transmission instruction from the communication controller 721, the loudspeaker controller 762 gives a transmission instruction to the loudspeaker 661 to allow the loudspeaker 661 to transmit the sound wave with the predetermined characteristic. The predetermined characteristic is explicitly or implicitly indicative of the identifier of the wave transmission node 700. For example, for the sound wave transmitted from the loudspeaker 661, at least one of the amplitude, phase, and frequency thereof may be modulated based on the identifier of the wave transmission source node 700.

The communication controller 721 controls the synchronization timer 122, the wireless receiver 723, the wireless transmitter 724, and the loudspeaker controller 762. For example, the communication controller 721 executes a synchronization process for synchronizing the synchronization timer 122 with the synchronization timer 122 built in another wave transmission node 700. For example, the communication controller 721 may allow the wireless transmitter 724 to transmit the timer value of the synchronization timer 122 to another wave transmission node 700 or may correct the timer value of the synchronization timer 122 using the timer value in another wave transmission node 700 received by the wireless receiver 723.

In addition, the communication controller 721 may give a transmission instruction to the loudspeaker controller 762 to allow the loudspeaker controller 762 to transmit a sound wave through the loudspeaker 661 at a predetermined timing. For example, the communication controller 721 may reference the timer value of the synchronization timer 122 and give a transmission instruction to the loudspeaker controller 762 when the timer value reaches a predetermined value corresponding to the predetermined timing.

Alternatively, the communication controller 721 may output a pulse wave with a predetermined period to the loudspeaker controller 762 based on the timer value of the synchronization timer 122. In this case, the loudspeaker controller 762 allows the loudspeaker 661 to transmit the sound wave in accordance with the pulse wave received from the communication controller 721. Furthermore, the frequency and phase of the pulse wave may be preset to predetermined values via wireless communication among wireless communicators 720-1, 720-2, 720-3, and 720-4. In this case, the communication controllers 721-1, 721-2, 721-3, and 721-4 can output a pulse wave with a synchronized frequency and a synchronized phase. That is, loudspeakers 661-1, 661-2, 661-3, and 661-4 can periodically and concurrently transmit the respective sound waves.

The wireless receiver 723 receives various types of information in the form of wireless signals. Specifically, the wireless receiver 723 receives information needed for the synchronization process (for example, the timer value of the synchronization timer 122 built in another wave reception node 700) from another wave reception node 100 in the form of wireless signals.

The wireless transmitter 724 transmits various types of information in the form of wireless signals. Specifically, the wireless transmitter 724 transmits information needed for the synchronization process (for example, the timer value of the synchronization timer 122) to another wave reception node 700 in the form of wireless signals.

The wave reception node 770 receives the wave. Upon detecting that the received wave has the above-described characteristic, the wave reception node 770 notifies the location estimator 740 that the wave reception node 770 has received the wave. The location estimator 740 is depicted to be incorporated in the wave reception node 770 in FIG. and FIG. 14, but may be provided outside the wave reception node 770.

A specific example of the wave reception node 770 is depicted in FIG. 14. The wave reception node 770 includes a wave receiver 710 and a location estimator 740. The wave receiver 710 receives the waves transmitted by the wave transmission nodes 700. Upon detecting that the received wave has the above-described characteristic, the wave receiver 710 notifies the location estimator 740 that the wave receiver 710 has received the desired wave in addition to notifying the location estimator 740 of the identifier of the wave transmission node 700 having transmitted the wave.

Upon receiving the notification from the wave receiver 710, the location estimator 740 accesses a built-in timer to acquire the reception time information. The timer may be built into the wave receiver 710 (for example, the detector 712) instead of the location estimator 740. In this case, the location estimator 740 can acquire the reception time information from the wave receiver 710. The timer may be referenced in order to calculate wave propagation time differences and need not synchronize with the synchronization timer 122. The location estimator 740 thus collects the reception time information on the wave transmitted by each wave transmission node 700 from the wave reception node 770.

The location estimator 740 estimates the location of the wave reception node 770 based on the collected reception time information, the velocity of the wave, and the location of each wave transmission node 700. The location estimator 740 can reference, for example, the identifier and location of each wave transmission node 700 and the velocity of the wave. The identifier and location of each wave transmission node 700 may be registered when the wave transmission node 700 is installed.

When the location of the wave reception node 770 is represented as (x, y, z), the location of the wave transmission node 700-i (i is an integer of at least 1 and at most 4) is represented as (xᵢ, yᵢ, zᵢ), the time of wave propagation from the wave transmission node 700-i to the wave reception node 770 is represented as tᵢ, and the velocity of the wave (for example, a sound wave) is represented as v, then Expression (1), described above, holds true.

Moreover, it is assumed that the wave transmission nodes 700-1, 700-2, 700-3, and 700-4 have transmitted the wave at the same timing. Then, when, for i >1, the difference between the reception time information on the wave from the wave transmission node 700-i and the reception time information on the wave from the wave transmission node 700-1 is represented as Δtᵢ, Expression (2), described above, holds true. The timings when the wave transmission nodes 700-1, 700-2, 700-3, and 700-4 need not be the same, and a predetermined time difference may be present among the timings. However, in particular, when the wave reception node 770 moves at high speed, the waves are preferably transmitted at the same timing in order to suppress location estimation errors.

Based on Expression (1) and Expression (2), Expression (3), described above, holds true for unknowns x, y, z, and t₁. In Expression (3), v, x₁, y₁ z₁, x₂, y₂, z₂, x₃, y₃, z₃, x₄, y₄, and z₄ are known to the location estimator 740. Furthermore, the location estimator 740 can calculate Δt₂, Δt₃, and Δt₄ based on the collected reception time information. Hence, the location estimator 740 can calculate the location (x, y, z) of the wave reception node 770 by solving Expression (3). Moreover, the location estimator 740 can calculate the distance from the wave transmission node 700-i to the wave reception node 770 by, for example, substituting x, y, and z into the right side of Expression (1).

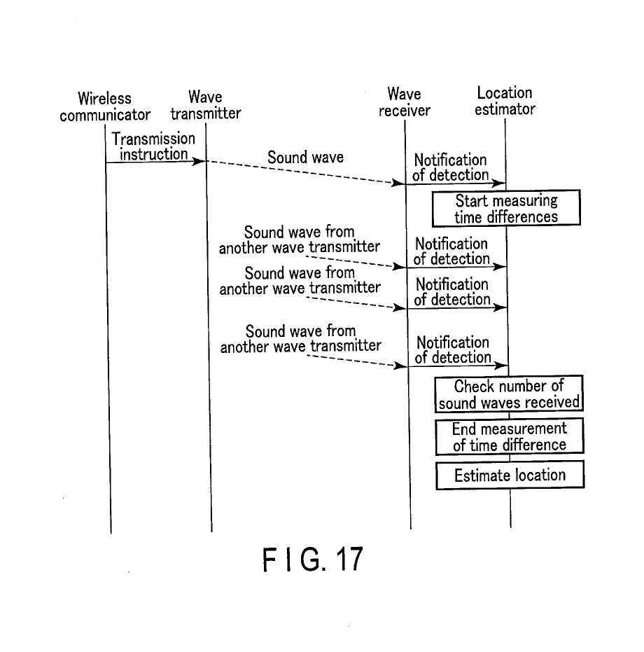

The location estimation system in FIG. 12 operates as illustrated in FIG. 17.

In each wave transmission node 700, the wireless communicator 720 allows the wave transmitter 760 to transmit a sound wave. The sound wave transmitted by each wave transmitter 760 is received by the wave receiver 710 in a propagation time commensurate with the distance from the wave transmitter 760 to the wave receiver 710.

Upon detecting that the received sound wave has a predetermined characteristic corresponding to the identifier of one of the wave transmission nodes 700, the wave receiver 710 notifies the location estimator 740 that the wave receiver 710 has received the identifier and the sound wave.

Upon receiving, from the wave receiver 710, the first notification that the wave receiver 710 has received the sound wave, the location estimator 740 starts measuring the propagation time differences of the other waves with reference to the reception time information on the sound wave received by the wave receiver 710. For example, the location estimator 740 may start the built-in timer. Subsequently, each time the location estimator 740 receives, from the wave receiver 710, a notification that the wave receiver 710 has received the sound wave, the location estimator 740 measures the propagation time differences of the sound waves. The propagation time differences correspond to Δt₂, Δt₃, Δt₄ in Expression (3), described above. The location estimator 740 can estimate the location of the wave reception node 770 provided that the location estimator 740 receives sound waves from at least four wave transmission nodes 700. Hence, given that the number of sound waves received has reached four, the location estimator 740 can end the measurement of the wave propagation time differences. For example, the location estimator 740 may stop the built-in timer. The location estimator 740 then estimates the location of the wave reception node 770 based on the measured propagation time differences, the velocity of the wave, and the location of each wave transmission node 700.

The wireless communicators 720-1, 720-2, 720-3, and 720-4 may form a star network instead of a peer-to-peer network. Furthermore, a master station may be provided independently of the wave transmission node 700.

As described above, the location estimation system according to the fourth embodiment includes the four or more wave transmission nodes, and the wireless communicators included in the respective wave transmission nodes form a wireless communication network. The location estimator collects the reception time information on the wave transmitted by each wave transmission node from the wave reception node.

The location estimator estimates the location of the wave reception node based on the collected reception time information, the velocity of the wave, and the location of each wave transmission node. The timers synchronize accurately with one another among the wave transmission nodes, and thus, the location estimator can collect accurate wave propagation time differences among the wave transmission nodes and accurately estimate the location of the wave reception node.

Furthermore, the wave transmission node can synchronously transmit the sound wave based on the timer value of the timer built in the wireless communicator in the wave transmission node. That is, the wave transmission node need not separately have, for example, hardware or software configured to execute a time synchronization process based on the NTP. The location estimation system needs no special apparatus for time synchronization such as an NTP server. In addition, the wave transmission nodes are wirelessly connected together. Thus, no communication cable needs to be laid, and the wireless communicator included in the wave transmission node may be implemented using, for example, general-purpose wireless LAN equipment compliant with IEEE 802.11. Hence, the location estimation system can be inexpensively, simply, and compactly constructed, and the apparatuses included in the location estimation system can be easily installed.

### Fifth Embodiment

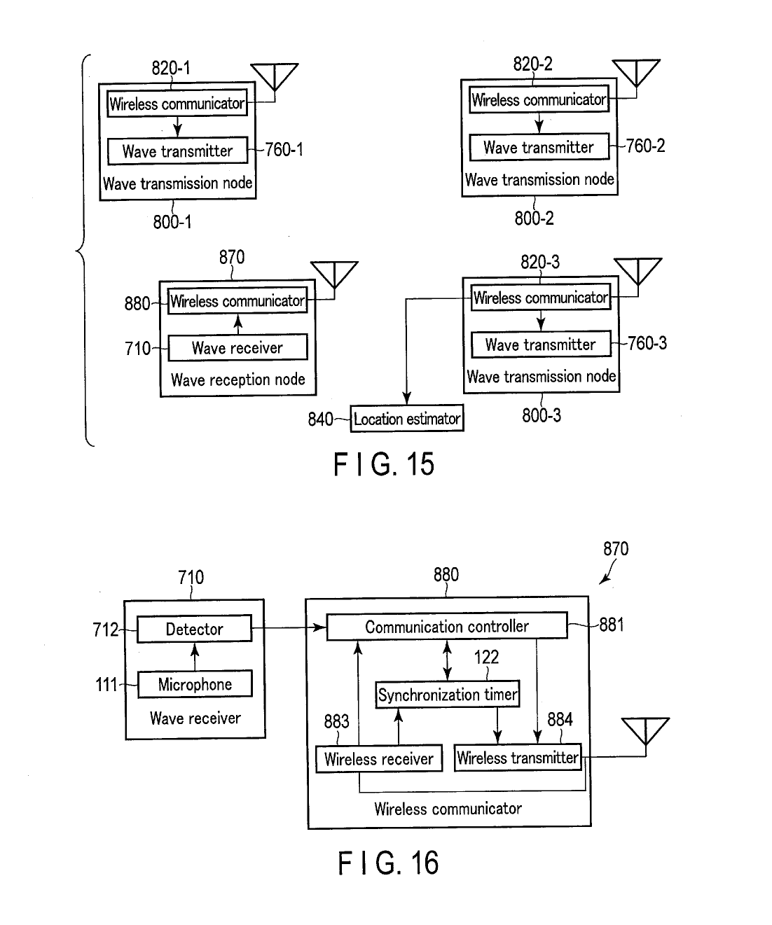

As illustrated in FIG. 15, a location estimation system according to a fifth embodiment includes three wave transmission nodes 800-1, 800-2, and 800-3, a location estimator 840, and a wave reception node 870. The total number of wave transmission nodes 800 may be four or more. Furthermore, the wave transmission node 800 or the wave reception node 870 may be replaced with a wave transmission and reception node.

In the location estimation system in FIG. 15, the wave transmission nodes 800-1, 800-2, and 800-3 transmit waves, and the wave reception nodes 870 receives the waves. The location estimator 840 can calculate the wave propagation times from the respective wave transmission nodes 800-1, 800-2, and 800-3 by subtracting the point in time of transmission of the wave by each of the wave transmission nodes 800-1, 800-2, and 800-3 from the point in time of reception of the wave by the wave reception node 870. Based on the wave propagation times, the location estimator 840 estimates the location of the wave reception node 870 and estimates the distance between the wave reception node 870 and any of the wave transmission nodes 800-1, 800-2, and 800-3.

The wave transmission node 800 can transmit a wave (for example, a sound wave). The wave may have a predetermined characteristic in order to be distinguished from other waves. The wave transmission node 800 may be an apparatus such as a robot with a loudspeaker. Upon transmitting the wave, the wave transmission node 800 acquires the transmission time information.

Specifically, the wave transmission node 800 includes a wireless communicator 820 and a wave transmitter 760. The wave transmitter 760 may transmit the wave with the predetermined characteristic and notify the wireless communicator 820 that the wave transmitter 760 has transmitted the wave. The timing when the wave transmitter 760 transmits the wave is controlled by the wireless communicator 820.

Upon receiving a notification from the wave transmitter 760, the wireless communicator 820 accesses a built-in timer to acquire the transmission time information. Alternatively, the wireless communicator 820 may access the built-in timer to acquire the transmission time information when giving the wave transmitter 760 a transmission instruction to transmit the wave. In this case, the wave transmitter 760 needs no notification function.

The wireless communicator 820 outputs the transmission time information to the location estimator 840. The location estimator 840 may be connected to any one of the wave transmission nodes 800-1, 800-2, and 800-3 in a wired or wireless manner. When directly connected to the location estimator 840, the wireless communicator 820 outputs the transmission time information directly to the location estimator 840. On the other hand, when not directly connected to the location estimator 840, the wireless communicator 820 outputs the transmission time information to the location estimator 840 via another wave transmission node 800. The wave transmission nodes 800-1, 800-2, and 800-3 synchronously transmit the waves, and thus, have substantially the same transmission time information. Therefore, when not directly connected to the location estimator 840, the wireless communicator 820 may omit outputting the transmission time information.

Moreover, the wireless communicator 820 references a timer synchronized with a timer built in another wireless communicator 820, and based on the timer value of the timer, controls the timing when the wave transmitter 760 is allowed to transmit the wave.

Specifically, the wireless communicator 820 includes a communication controller 821, a synchronization timer 122, a wireless receiver 823, and a wireless transmitter 824.

The communication controller 821 controls the synchronization timer 122, the wireless receiver 823, and the wireless transmitter 824. For example, upon receiving a notification from the loudspeaker controller 762, the communication controller 821 acquires the timer value of the synchronization timer 122. The timer value corresponds to the transmission time information. The communication controller 821 outputs the transmission time information to the location estimator 840.

Specifically, when directly connected to the location estimator 840, the wireless communicator 821 outputs the transmission time information directly to the location estimator 840. On the other hand, when not directly connected to the location estimator 840, the wireless communicator 821 allows the wireless transmitter 824 to transmit the transmission time information to the location estimator 840 or another wave transmission node 800. When the wireless receiver 823 receives the transmission time information from the wave transmission node 800, the communication controller 821 similarly outputs the transmission time information to the location estimator 840.

Moreover, the communication controller 821 executes a synchronization process for synchronizing the synchronization timer 122 with the synchronization timer 122 built in another wave transmission node 800 and the wave reception node 870. For example, the communication controller 821 may allow the wireless transmitter 824 to transmit the timer value of the synchronization timer 122 to another wave transmission node 800 and the wave reception node 870 or may correct the timer value of the synchronization timer 122 using the timer value in another wave transmission node 800 or the timer value in the wave reception node 870, received by the wireless receiver 823.

In addition, the communication controller 821 gives a transmission instruction to the loudspeaker controller 762 to allow the loudspeaker controller 762 to transmit a sound wave through the loudspeaker 661 at a predetermined timing. For example, the communication controller 821 may reference the timer value of the synchronization timer 122 and give the transmission instruction to the loudspeaker controller 762 when the timer value reaches a predetermined value corresponding to the predetermined timing.

Alternatively, the communication controller 821 may output a pulse wave with a predetermined period to the loudspeaker controller 762 based on the timer value of the synchronization timer 122. In this case, the loudspeaker controller 762 allows the loudspeaker 661 to transmit the sound wave in accordance with the pulse wave received from the communication controller 821. Furthermore, the frequency and phase of the pulse wave may be preset to predetermined values via wireless communication among wireless communicators 720-1, 720-2, and 720-3. In this case, the communication controllers 821-1, 821-2, and 821-3 can output a pulse wave with a synchronized frequency and a synchronized phase. That is, loudspeakers 661-1, 661-2, and 661-3 can periodically and concurrently transmit the respective sound waves.

The wireless receiver 823 receives various types of information in the form of wireless signals. Specifically, the wireless receiver 823 receives information needed for the synchronization process the reception time information or the transmission time information, and (for example, the timer values of the synchronization timer 122 built in another wave transmission node 800 or the synchronization timer 122 built in the wave reception node 870) from another wave transmission node 800 or the wave reception node 800 in the form of wireless signals.

The wireless transmitter 824 transmits various types of information in the form of wireless signals.

Specifically, the wireless transmitter 824 transmits the transmission time information and information needed for the synchronization process (for example, the timer value of the synchronization timer 122) to another wave transmission node 800 and the location estimator 840 in the form of wireless signals. The wireless transmitter 824 may transmit the identifier of the wave transmission node 800 along with the transmission time information.

The wave reception node 870 receives the wave. Upon detecting that the received wave has the above-described characteristic, the wave reception node 870 acquires the reception time information. Specifically, the wave reception node 870 includes a wave receiver 710 and a wireless communicator 880.

Each time the wireless communicator 880 receives a notification from the wave receiver 710, the wireless communicator 880 accesses a built-in timer to acquire the reception time information. The wireless communicator 880 outputs the reception time information and the identifier of the corresponding wave transmission node 800 to the location estimator 840. The location estimator 840 may be connected to any one of the wave transmission nodes 800-1, 800-2, and 800-3 in a wired or wireless manner. In this case, the wireless communicator 880 outputs the reception time information and the identifier to the location estimator 840 via the wave transmission node 800.

A specific example of the wave reception node 870 is depicted in FIG. 16. The wireless communicator 880 includes a communication controller 881, the synchronization timer 122, a wireless receiver 883, and a wireless transmitter 884.

The communication controller 881 controls the synchronization timer 122, the wireless receiver 883, and the wireless transmitter 884. For example, upon receiving a notification from the detector 712 (the notification includes the identifier of the wave transmission node 800 corresponding to the transmission source for the wave received by the wave receiver 710), the communication controller 881 acquires the timer value of the synchronization timer 122. The timer value corresponds to the reception time information. The communication controller 881 outputs the reception time information and the identifier of the corresponding wave transmission node 800 to the location estimator 840. Specifically, the communication controller 881 allows the wireless transmitter 884 to transmit the reception time information and the identifier to the location estimator 840 or the wave transmission nodes 800.

Moreover, the communication controller 881 executes a synchronization process for synchronizing the synchronization timer 122 with the synchronization timer 122 built in the wave transmission node 800. For example, the communication controller 881 may allow the wireless transmitter 884 to transmit the timer value of the synchronization timer 122 to the wave transmission node 800 and the wave reception node 870 or may correct the timer value of the synchronization timer 122 using the timer value in the wave transmission node 800 received by the wireless receiver 883.

The wireless receiver 883 receives various types of information in the form of wireless signals. Specifically, the wireless receiver 883 receives information needed for the synchronization process (for example, the timer value of the synchronization timer 122 built in the wave transmission node 800) from the wave transmission node 800 in the form of wireless signals.

The wireless transmitter 884 transmits various types of information in the form of wireless signals. Specifically, the wireless transmitter 884 transmits the reception time information and the identifier of the corresponding wave transmission node 800, and information needed for the synchronization process (for example, the timer value of the synchronization timer 122) to the wave transmission nodes 800, the location estimator 840, and the like in the form of wireless signals.

The location estimator 840 collects the transmission time information from the wave transmission nodes 800-1, 800-2, and 800-3 and collects, from the wave reception node 870, the reception time information on the wave transmitted by each wave transmission node 800. The location estimator 840 estimates the location of the wave reception node 870 based on the collected reception time information and transmission time information, the velocity of the wave, and the location of the wave transmission node 800. The location estimator 840 can reference, for example, the identifier and location of the wave transmission node 800 and the velocity of the wave. The identifier and location of the wave transmission node 800 may be registered when the wave transmission node 800 is installed.

When the location of the wave reception node 870 is represented as (x, y, z), the location of the wave transmission node 800-i (i is an integer of at least 1 and at most 3) is represented as (xᵢ, yᵢ, zᵢ), the time of wave propagation from the wave transmission node 800-i to the wave reception node 870 is represented as tᵢ, and the velocity of the wave (for example, a sound wave) is represented as v, then Expression (4), described above, holds true.

In Expression (4), v, xᵢ, yᵢ, and z₁ are known to the location estimator 840. Moreover, tᵢ can be calculated using the difference between the transmission time information collected from the wave transmission node 800-i and the reception time information collected from the wave reception node 870 and corresponding to the wave transmission node 800-j. Hence, the location estimator 840 can calculate the location (x, y, z) of the wave reception node 870 by solving a linear simultaneous equation with three unknowns derived from Expression (4). Moreover, the location estimator 840 can calculate the distance from the wave reception node 870 to the wave transmission and reception node 800-i by, for example, substituting tᵢ into the left side of Expression (4).

Even when the wave transmission node 800 does not transmit the transmission time information, the location estimator 840 can estimate the location of the wave reception node by solving Expression (3), described above, as long as the total number of wave transmission nodes 800 is four or more.

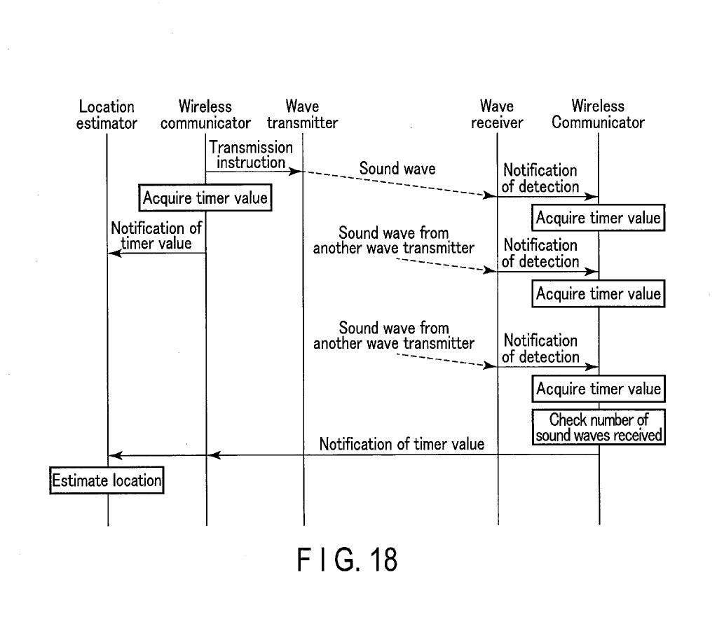

The location estimation system in FIG. 15 operates as illustrated in FIG. 18.

In each wave transmission node 800, the wireless communicator 820 allows the wave transmitter 760 to transmit a sound wave. The sound wave transmitted by each wave transmitter 760 is received by the wave receiver 710 in a propagation time commensurate with the distance from the wave transmitter 760 to the wave receiver 710.

The wireless communicator 820 accesses the built-in synchronization timer 122 to acquire the transmission time information when giving the wave transmitter 760 a transmission instruction to transmit the wave. The wireless communicator 820 then outputs the transmission time information to the location estimator 840.

Upon detecting that the received sound wave has a predetermined characteristic corresponding to the identifier of one of the wave transmission nodes 800, the wave receiver 710 notifies the wireless communicator 880 that the wave receiver 710 has received the identifier and the sound wave.

Each time the wireless communicator 880 receives, from the wave receiver 710, a notification that the wave receiver 710 has received the sound wave, the wireless communicator 880 acquires the reception time information on the sound wave from the synchronization timer 122. The location estimator 840 can estimate the location of the wave reception node 870 provided that the wireless communicator 880 receives the sound wave from at least three wave transmission nodes 800. Hence, given that the number of sound waves received has reached three, the wireless communicator 880 transmits at least three sets of reception time information (timer values) and the identifiers of the corresponding wave transmission nodes 800 to the location estimator 840.

The location estimator 840 estimates the location of the wave reception node 870 based on the transmission time information and the reception time information, the velocity of the wave, and the location of each wave transmission node 800.

The wireless communicators 820-1, 820-2, 820-3, and 880 may form a star network instead of a peer-to-peer network. Furthermore, a master station may be provided independently of the wave transmission node 800 and the wave reception node 870. Moreover, the location estimator 840 may be incorporated into any of the wireless communicators 820-1, 820-2, and 820-3.

As described above, the location estimation system according to the fifth embodiment includes the three or more wave transmission nodes and the wave reception node, and the wireless communicators included in the respective wave transmission nodes and in the wave reception node form a wireless communication network. At least one wave transmission node acquires the transmission time information from the timer built in the wireless communicator in the wave transmission node and outputs the transmission time information to the location estimator. On the other hand, the wave reception node acquires the reception time information on the wave transmitted by each wave transmission node, from the timer built in the wave reception node, and outputs the reception time information to the location estimator along with the identifier of the wave transmission node.

The location estimator estimates the location of the wave reception node based on the collected transmission time information and reception time information, the velocity of the wave, and the location of each wave transmission node. The timers synchronize accurately with one another among the wave transmission nodes and the wave reception node, and thus, the location estimator can collect accurate wave propagation times from the wave transmission nodes and accurately estimate the location of the wave reception node.

Furthermore, the wave transmission node can synchronously transmit the sound wave based on the timer value of the timer built in the wireless communicator in the wave transmission node. Moreover, the wave reception node can acquire the reception time information from the timer built in the wireless communicator in the wave reception node. That is, the wave transmission node and the wave reception node need not separately have, for example, hardware or software configured to execute a time synchronization process based on the NTP. The location estimation system needs no special apparatus for time synchronization such as an NTP server. In addition, the wave transmission node and the wave reception node are wirelessly connected together. Thus, no communication cable needs to be laid, and the wireless communicators included in the wave transmission node and wave reception node may be implemented using, for example, general-purpose wireless LAN equipment compliant with IEEE 802.11. Hence, the location estimation system can be inexpensively, simply, and compactly constructed, and the apparatuses included in the location estimation system can be easily installed.

At least a part of the processing in the above-described embodiments can be implemented using a general-purpose computer as basic hardware. A program implementing the processing in each of the above-described embodiments may be stored in a computer readable storage medium for provision. The program is stored in the storage medium as a file in an installable or executable format. The storage medium is a magnetic disk, an optical disc (CD-ROM, CD-R, DVD, or the like), a magnetooptic disc (MO or the like), a semiconductor memory, or the like. That is, the storage medium may be in any format provided that a program can be stored in the storage medium and that a computer can read the program from the storage medium. Furthermore, the program implementing the processing in each of the above-described embodiments may be stored on a computer (server) connected to a network such as the Internet so as to be downloaded into a computer (client) via the network.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An estimation system comprising:
a node group that includes a first node receiving a first wave and a second node communicating wirelessly with the first node; and
an estimator that estimates, based on a propagation time of the first wave, (i) a distance from a first transmission source having transmitted the first wave to the first node or (ii) a location of the first transmission source or the first node, wherein
the first node comprises:
a first wave receiver that receives the first wave; and
a first wireless communicator that incorporates a first timer, synchronizes the first timer with a second timer built in the second node via wireless communication with the second node, acquires a first piece of reception time information indicative of a point in time of reception of the first wave from the first timer, and outputs the first piece of reception time information to the estimator.

2. The system according to claim 1, wherein
the node group further includes a third node and a fourth node that communicate wirelessly with the first node and the second node,
the first wireless communicator synchronizes the first timer with a second timer, a third timer, and a fourth timer built in the second node, the third node, and the fourth node via wireless communication with the second node, the third node, and the fourth node,
the second node comprises:
a second wave receiver that receives the first wave; and
a second wireless communicator that incorporates the second timer, synchronizes the second timer with the first timer, the third timer, and the fourth timer via wireless communication with the first node, the third node, and the fourth node, acquires a second piece of reception time information indicative of the point in time of reception of the first wave from the second timer, and outputs the second piece of reception time information to the estimator,
the third node comprises:
a third wave receiver that receives the first wave; and
a third wireless communicator that incorporates the third timer, synchronizes the third timer with the first timer, the second timer, and the fourth timer via wireless communication with the first node, the second node, and the fourth node, acquires a third piece of reception time information indicative of the point in time of reception of the first wave from the third timer, and outputs the third piece of reception time information to the estimator,
the fourth node comprises:
a fourth wave receiver that receives the first wave; and
a fourth wireless communicator that incorporates the fourth timer, synchronizes the fourth timer with the first timer, the second timer, and the third timer via wireless communication with the first node, the second node, and the third node, acquires a fourth piece of reception time information indicative of the point in time of reception of the first wave from the fourth timer, and outputs the fourth piece of reception time information to the estimator, and
the estimator calculates propagation time differences between a propagation time of the first wave from the first transmission source to the first node and propagation times of the first wave from the first transmission source to the second node, the third node, and the fourth node based on the first piece of reception time information, the second piece of reception time information, the third piece of reception time information, and the fourth piece of reception time information to estimate a location of the first transmission source based on the propagation time differences.

3. The system according to claim 1, wherein
the first wave is a sound wave,
the first wave receiver comprises:
a microphone that receives and converts the sound wave into an electric signal; and
a detector that checks whether or not the electric signal comprises a predetermined characteristic, and upon detecting that the electric signal comprises the predetermined characteristic, notifies the first wireless communicator that a desired sound wave has been received, and
the first wireless communicator, upon receiving the notification from the detector, acquires the first piece of reception time information from the first timer.

4. The system according to claim 1, wherein
the first wave is a sound wave,
the first wave receiver comprises:
a microphone that receives and converts the sound wave into an electric signal; and
a converter that converts the electric signal into digital data,
the first wireless communicator outputs the first piece of reception time information and the digital data to the estimator, and
the estimator checks whether or not the digital data comprises a predetermined characteristic, and upon detecting that the digital data comprises the predetermined characteristic, estimates, based on the first piece of reception time information corresponding to the digital data, (i) a distance from the first transmission source to the first node or (ii) a location of the first transmission source or the first node.

5. The system according to claim 1, wherein
the first transmission source is the second node,
the second node comprises:
a first wave transmitter that transmits the first wave; and
a second wireless communicator that incorporates the second timer, synchronizes the second timer with the first timer via wireless communication with the first node, acquires transmission time information indicative of a point in time of transmission of the first wave from the second timer, and outputs the transmission time information to the estimator, and
the estimator calculates a propagation time of the first wave from the second node to the first node by subtracting the transmission time information from the first piece of reception time information, and based on the propagation time, estimates a distance from the second node to the first node.

6. The system according to claim 5, wherein
the second wireless communicator, upon wirelessly receiving an instruction to transmit the first wave, gives the first wave transmitter the instruction to transmit the first wave, and
the first wave transmitter, when given the instruction to transmit the first wave by the second wireless communicator, transmits the first wave.

7. The system according to claim 1, wherein
the node group further includes a third node and a fourth node that communicate wirelessly with the first node and the second node,
the first transmission source is the fourth node,
the first wireless communicator synchronizes the first timer with the second timer, a third timer, and a fourth timer built in the second node, the third node, and the fourth node via wireless communication with the second node, the third node, and the fourth node,
the second node comprises:
a second wave receiver that receives the first wave; and
a second wireless communicator that incorporates the second timer, synchronizes the second timer with the first timer, the third timer, and the fourth timer via wireless communication with the first node, the third node, and the fourth node, acquires a second piece of reception time information indicative of the point in time of reception of the first wave from the second timer, and outputs the second piece of reception time information to the estimator,
the third node comprises:
a third wave receiver that receives the first wave; and
a third wireless communicator that incorporates the third timer, synchronizes the third timer with the first timer, the second timer, and the fourth timer via wireless communication with the first node, the second node, and the fourth node, acquires a third piece of reception time information indicative of the point in time of reception of the first wave from the third timer, and outputs the third piece of reception time information to the estimator,
the fourth node comprises:
a first wave transmitter that transmits the first wave; and
a fourth wireless communicator that incorporates the fourth timer, synchronizes the fourth timer with the first timer, the second timer, and the third timer via wireless communication with the first node, the second node, and the third node, acquires transmission time information indicative of the point in time of transmission of the first wave from the fourth timer, and outputs the transmission time information to the estimator, and
the estimator subtracts the transmission time information from the first piece of reception time information, the second piece of reception time information, and the third piece of reception time information to calculate propagation times from the fourth node to the first node, the second node, and the third node, and based on the propagation times, estimates a location of the fourth node.

8. The system according to claim 7, wherein
the fourth wireless communicator, upon wirelessly receiving an instruction to transmit the first wave, gives the first wave transmitter the instruction to transmit the first wave, and
the first wave transmitter, when given the instruction to transmit the first wave by the fourth wireless communicator, transmits the first wave.

9. The system according to claim 1, wherein
the node group further includes a third node and a fourth node that communicate wirelessly with the first node and the second node,
the first transmission source is the second node,
the second node comprises:
a first wave transmitter that transmits the first wave; and
a second wireless communicator that incorporates the second timer, synchronizes the second timer with the first timer, a third timer, and a fourth timer built in the first node, the third node, and the fourth node via wireless communication with the first node, the third node, and the fourth node, controls a timing when the first wave transmitter transmits the first wave based on a timer value of the second timer, acquires transmission time information indicative of a point in time of transmission of the first wave from the second timer, and outputs the transmission time information to the estimator,
the third node comprises:
a second wave transmitter that transmits a second wave; and
a third wireless communicator that incorporates the third timer, synchronizes the third timer with the first timer, the second timer, and the fourth timer via wireless communication with the first node, the second node, and the fourth node, and controls a timing when the second wave transmitter transmits the second wave based on a timer value of the third timer,
the fourth node comprises:
a third wave transmitter that transmits a third wave; and
a fourth wireless communicator that incorporates the fourth timer, synchronizes the fourth timer with the first timer, the second timer, and the third timer via wireless communication with the first node, the second node, and the third node, and controls a timing when the third wave transmitter transmits the third wave based on a timer value of the fourth timer,
the first wave receiver receives the first wave, the second wave, and the third wave,
the first wireless communicator synchronizes the first timer with the second timer, the third timer, and the fourth timer via wireless communication with the second node, the third node, and the fourth node, acquires a first piece of reception time information, a second piece of reception time information, and a third piece of reception time information indicative of the points in time of reception of the first wave, the second wave, and the third wave, respectively, from the first timer, and outputs the first piece of reception time information, the second piece of reception time information, and the third piece of reception time information to the estimator, and
the estimator subtracts the transmission time information from the first piece of reception time information, the second piece of reception time information, and the third piece of reception time information to calculate propagation times of the first wave, the second wave, and the third wave from the second node, the third node, and the fourth node, respectively, to the first node, and based on the propagation times, estimates a location of the first node.

10. The system according to claim 1, wherein
a second wireless communicator built in the second node corresponds to a master station in a star network and wirelessly transmits a timer value of the second timer to the first wireless communicator,
the first wireless communicator corresponds to a slave station in the star network, corrects the first timer based on the timer value of the second timer, and transmits the first piece of reception time information to the second wireless communicator, and
the second wireless communicator outputs the first piece of reception time information to the estimator.

11. The system according to claim 1, further comprising a wireless communication apparatus that corresponds to a master station in a star network, and wherein
the first wireless communicator and a second wireless communicators built in the second node correspond to slave stations in the star network,
the first wireless communicator and the second wireless communicator communicate wirelessly via the wireless communication apparatus.

12. The system according to claim 1, wherein the estimator is wirelessly connected to a second wireless communicator built in the second node.

13. The system according to claim 1, wherein the estimator is built in a second wireless communicator built in the second node.

14. An estimation system comprising:
a transmission node group that includes a first transmission node, a second transmission node, a third transmission node, and a fourth transmission node that transmit a first wave, a second wave, a third wave, and a fourth wave and communicates wirelessly with one another;
a reception node that receives the first wave, the second wave, the third wave, and the fourth wave;
an estimator that estimates a location of the reception node based on propagation times of the first wave, the second wave, the third wave, and the fourth wave, wherein
the first transmission node comprises:
a first wave transmitter that transmits the first wave; and
a first wireless communicator that incorporates a first timer, synchronizes the first timer with a second timer, a third timer, and a fourth timer built in the second transmission node, the third transmission node, and the fourth transmission node via wireless communication with the second transmission node, the third transmission node, and the fourth transmission node, and controls a timing when the first wave transmitter transmits the first wave based on a timer value of the first timer,
the second transmission node comprises:
a second wave transmitter that transmits the second wave; and
a second wireless communicator that incorporates the second timer, synchronizes the second timer with the first timer, the third timer, and the fourth timer via wireless communication with the first transmission node, the third transmission node, and the fourth transmission node, and controls a timing when the second wave transmitter transmits the second wave based on a timer value of the second timer,
the third transmission node comprises:
a third wave transmitter that transmits the third wave; and
a third wireless communicator that incorporates the third timer, synchronizes the third timer with the first timer, the second timer, and the fourth timer via wireless communication with the first transmission node, the second transmission node, and the fourth transmission node, and controls a timing when the third wave transmitter transmits the third wave based on a timer value of the third timer,
the fourth transmission node comprises:
a fourth wave transmitter that transmits the fourth wave; and
a fourth wireless communicator that incorporates the fourth timer, synchronizes the fourth timer with the first timer, the second timer, and the third timer via wireless communication with the first transmission node, the second transmission node, and the third transmission node, and controls a timing when the fourth wave transmitter transmits the fourth wave based on a timer value of the fourth timer,
the reception node notifies the estimator that the reception node has received the first wave, the second wave, and the third wave, and
the estimator calculates propagation time differences between a propagation time of the first wave from the first transmission node to the reception node and propagation times of the second wave, the third wave, and the fourth wave from the second transmission node, the third transmission node, and the fourth transmission node to the reception node based on points in time of reception of notifications that the first wave, the second wave, the third wave, and the fourth wave, respectively, have been received from the reception node, to estimate the location of the reception node based on the propagation time differences.

15. A reception node comprising:
a wave receiver that receives a sound wave; and
a wireless communicator that incorporates a first timer, synchronizes the first timer with a second timer built in another node via wireless communication with the other node, and acquires reception time information indicative of a point in time of reception of the sound wave from the first timer.
